(19) United States
(12) Patent Application Publication
(10) Pub. No.: US 2023/0386515 A1
(43) Pub. Date: Nov. 30, 2023

(54) MAGNETIC RECORDING MEDIUM, MAGNETIC TAPE CARTRIDGE, AND MAGNETIC RECORDING AND REPRODUCING DEVICE

(71) Applicant: FUJIFILM Corporation, Tokyo (JP)

(72) Inventors: Takashi FUJIMOTO, Minamiashigara-shi (JP); Eiki Ozawa, Minamiashigara-shi (JP)

(73) Assignee: FUJIFILM Corporation, Tokyo (JP)

(21) Appl. No.: 18/449,307

(22) Filed: Aug. 14, 2023

Related U.S. Application Data
(63) Continuation of application No. PCT/JP2022/007649, filed on Feb. 24, 2022.

(30) Foreign Application Priority Data
Feb. 26, 2021 (JP) 2021-030918

(51) Int. Cl. G11B 5/706; G11B 5/735; G11B 5/702; G11B 5/78

(52) U.S. Cl. CPC G11B 5/70621; G11B 5/7356; G11B 5/7021; G11B 5/78

(57) ABSTRACT

Provided are a magnetic recording medium including a non-magnetic support, and a magnetic layer including a ferromagnetic powder. The ferromagnetic powder is an ε-iron oxide powder, and an intensity ratio (Int1/Int2) of diffraction intensities obtained by an X-ray diffraction analysis of the magnetic layer using an In-Plane method is 1.0 or more and 6.5 or less; and a magnetic tape cartridge and a magnetic recording and reproducing device each including the magnetic recording medium.

### CROSS-REFERENCE TO RELATED APPLICATIONS

This application is a Continuation of PCT International Application No. PCT/JP2022/007649 filed on Feb. 24, 2022, which claims priority under 35 U.S.C. § 119(a) to Japanese Patent Application No. 2021-030918 filed on Feb. 26, 2021. Each of the above applications is hereby expressly incorporated by reference, in its entirety, into the present application.

### BACKGROUND OF THE INVENTION

### 1. Field of the Invention

The present invention relates to a magnetic recording medium, a magnetic tape cartridge, and a magnetic recording and reproducing device.

### 2. Description of the Related Art

A magnetic recording medium has been widely used as a data storage recording medium for recording and storing various pieces of data (see, for example, JP2016-130208A).

### SUMMARY OF THE INVENTION

In a magnetic recording medium, a magnetic layer containing a ferromagnetic powder is usually provided on a non-magnetic support. Regarding the ferromagnetic powder, for example, as disclosed in JP2016-130208A, an ε-iron oxide powder has attracted attention in recent years.

In general, recording of data on a magnetic recording medium and reproducing of recorded data are performed by running the magnetic recording medium in a magnetic recording and reproducing device (generally referred to as a “drive”) and causing a magnetic layer surface and a magnetic head to come into contact with each other to be slid on each other. The occurrence of large friction between the magnetic layer surface and the magnetic head during such sliding may cause sticking between the magnetic layer surface and the magnetic head. Therefore, it is desired that the magnetic recording medium has small friction during sliding on the magnetic head. However, as a result of studies by the present inventor, as for a magnetic recording medium including a magnetic layer containing an ε-iron oxide powder as a ferromagnetic powder, there was a tendency that the magnetic layer surface was likely to stick to the magnetic head because of large friction (hereinafter, also referred to simply as “friction”) during sliding on the magnetic head, although the reason is not clear.

In view of the above, an aspect of the present invention is to provide a magnetic recording medium that includes a magnetic layer containing an ε-iron oxide powder as a ferromagnetic powder and in which friction is suppressed.

An aspect of the present invention relates to a magnetic recording medium comprising: a non-magnetic support; and a magnetic layer containing a ferromagnetic powder, in which the ferromagnetic powder is an ε-iron oxide powder, and an intensity ratio (Int1/Int2) of diffraction intensities obtained by an X-ray diffraction analysis of the magnetic layer using an In-Plane method is 1.0 or more and 6.5 or less.

The Int1 is a maximum value of a diffraction intensity in a range in which a diffraction angle2θ_{χ} is 29.0° or more and 31.0° or less, and the Int2 is a maximum value of a diffraction intensity in a range in which the diffraction angle2θ_{χ} is 36.3° or more and 37.5° or less. The term “Int” is used as abbreviation for intensity.

In one embodiment, the intensity ratio (Int1/Int2) may be 1.5 or more and 6.0 or less.

In one embodiment, the intensity ratio (Int1/Int2) may be 3.0 or more and 5.5 or less.

In one embodiment, the ε-iron oxide powder may contain a cobalt element.

In one embodiment, the ε-iron oxide powder may further contain an element selected from the group consisting of a gallium element and an aluminum element.

In one embodiment, the ε-iron oxide powder may further contain a titanium element.

In one embodiment, the magnetic recording medium may further comprise a non-magnetic layer containing a non-magnetic powder between the non-magnetic support and the magnetic layer.

In one embodiment, the magnetic recording medium may further comprise a back coating layer containing a non-magnetic powder on a surface side of the non-magnetic support opposite to a surface side on which the magnetic layer is provided.

In one embodiment, the magnetic recording medium may be a magnetic tape.

Another aspect of the present invention relates to a magnetic tape cartridge comprising the magnetic tape described above.

Still another aspect of the present invention relates to a magnetic recording and reproducing device comprising the magnetic recording medium.

According to one aspect of the present invention, it is possible to provide a magnetic recording medium that includes a magnetic layer containing an ε-iron oxide powder as a ferromagnetic powder and in which friction is suppressed. In addition, according to one aspect of the present invention, it is possible to provide a magnetic tape cartridge and a magnetic recording and reproducing device including the magnetic recording medium.

### DESCRIPTION OF THE PREFERRED EMBODIMENTS

[Magnetic Recording Medium]

An aspect of the present invention relates to a magnetic recording medium including a non-magnetic support, and a magnetic layer containing a ferromagnetic powder. The ferromagnetic powder is an ε-iron oxide powder, and an intensity ratio (Int1/Int2) of diffraction intensities obtained by an X-ray diffraction analysis of the magnetic layer using an In-Plane method is 1.0 or more and 6.5 or less. The Int1 is a maximum value of a diffraction intensity in a range in which a diffraction angle2θ_{χ} is 29.0° or more and 31.0° or less, and the Int2 is a maximum value of a diffraction intensity in a range in which the diffraction angle2θ_{χ} is 36.3° or more and 37.5° or less.

### Intensity Ratio (Int1/Int2)

In the present invention and the present specification, the intensity ratio (Int1/Int2) is a value obtained by the following method.

The intensity ratio (Int1/Int2) is obtained by an X-ray diffraction analysis of a magnetic layer containing an ε-iron oxide powder using the In-Plane method. Hereinafter, the X-ray diffraction analysis performed using the In-Plane method is also referred to as “In-Plane XRD”. The term “XRD” is an abbreviation for X-ray diffraction. The In-Plane XRD is performed by irradiating a magnetic layer surface with X-rays under the following conditions using a thin-film X-ray diffractometer. A measurement direction is a direction orthogonal to a longitudinal direction for a magnetic tape, and is a direction orthogonal to a radial direction for a magnetic disk.
Use of Cu ray source (output of 45 kV, 200 μmA)
Scan condition: scanning a range of 200 to 400 (degrees) at 0.05°/step and 0.1°/min
Optical system used: parallel optical system
Measurement method: 2θ_{χ} scan (X-ray incidence angle of 0.25°)

The above-described conditions are set values in the thin-film X-ray diffractometer. A well-known device can be used as the thin-film X-ray diffractometer. As the thin-film X-ray diffractometer, SmartLab manufactured by Rigaku Corporation can be exemplified. A sample to be subjected to the In-Plane XRD analysis is a sample cut out from the magnetic recording medium which is a measurement target, and the size and the shape thereof are not limited, as long as an X-ray diffraction spectrum, which will be described below, can be confirmed.

As a method of the X-ray diffraction analysis, thin-film X-ray diffraction and powder X-ray diffraction are used. In the powder X-ray diffraction, X-ray diffraction of a powder sample is measured, whereas, according to the thin-film X-ray diffraction, X-ray diffraction of a layer or the like formed on a substrate can be measured. The thin-film X-ray diffraction is classified into the In-Plane method and an Out-Of-Plane method. The X-ray incidence angle during the measurement is usually in a range of 5.00° to 90.00° in the Out-Of-Plane method, whereas the X-ray incidence angle is usually in a range of 0.20° to 0.50° in the In-Plane method. In the In-Plane XRD of the present invention and the present specification, the X-ray incidence angle is 0.25° as described above. In the In-Plane method, the X-ray incidence angle is smaller than that in the Out-Of-Plane method, and thus, a depth of penetration of the X-ray is shallow. Therefore, according to the X-ray diffraction analysis by using the In-Plane method (In-Plane XRD), it is possible to perform the X-ray diffraction analysis of a surface layer portion of a measurement target sample. According to the In-Plane XRD, it is possible to perform the X-ray diffraction analysis of the magnetic layer on a sample cut out from the magnetic recording medium. In the X-ray diffraction spectrum (vertical axis: diffraction intensity, horizontal axis: diffraction angle 2θ_{χ} (°)) obtained by the In-Plane XRD, the maximum value of the diffraction intensity in a range of 29.0°<20X<31.0° is “Int1”, and the maximum value of the diffraction intensity in a range of 36.3°<20X<37.5° is “Int2”. The intensity ratio (Int1/Int2) is calculated as a ratio of Int1 and Int2 thus obtained.

The present inventor considers that the above-mentioned intensity ratio (Int1/Int2) obtained for a magnetic layer containing an ε-iron oxide powder is a value that can be an index of a presence state of the ε-iron oxide powder in the magnetic layer. More specifically, the present inventor supposes this point as follows.

As a component that can contribute to suppressing friction during sliding between the magnetic layer surface and the magnetic head, a lubricant described below can be exemplified. For the intensity ratio (Int1/Int2), the present inventor considers that the value of the intensity ratio (Int1/Int2) becomes larger as particles of the ε-iron oxide powder are present in a surface layer portion of the magnetic layer in a state where a specific crystal plane of the particles with a strong bonding force with the lubricant is aligned more parallel to the magnetic layer surface. The present inventor supposes that the more such crystal plane is aligned more parallel to the magnetic layer surface, the more a functional group that can exert a lubricating function of the lubricant can be exposed to the magnetic layer surface, thereby suppressing the friction during sliding between the magnetic layer surface and the magnetic head. Note that the present invention is not limited to the supposition described in the present specification.

From the viewpoint of suppressing the friction of the magnetic recording medium including the magnetic layer containing the ε-iron oxide powder, the intensity ratio (Int1/Int2) is 1.0 or more, preferably 1.5 or more, more preferably 2.0 or more, still more preferably 2.5 or more, still more preferably 3.0 or more, and still more preferably 3.5 or more. In addition, it is supposed that, in a case where the intensity ratio (Int1/Int2) is 6.5 or less, the amount by which the functional group that can exert the lubricating function of the lubricant is exposed to the magnetic layer surface can be maintained at an appropriate amount. The present inventor considers that this also contributes to suppressing the friction of the magnetic recording medium including the magnetic layer containing the ε-iron oxide powder. From this viewpoint, the intensity ratio (Int1/Int2) of the magnetic recording medium is 6.5 or less, preferably 6.0 or less, and more preferably 5.5 or less. A control method of the intensity ratio (Int1/Int2) will be described below.

Hereinafter, the magnetic recording medium will be further described in detail.

### Magnetic Layer

<<ε-Iron Oxide Powder>>

The magnetic recording medium contains an ε-iron oxide powder as a ferromagnetic powder in a magnetic layer. In the present invention and the present specification, the term “ε-iron oxide powder” refers to a ferromagnetic powder in which an ε-iron oxide crystal structure (F phase) is detected as a main phase by X-ray diffraction analysis. For example, in a case where the highest intensity diffraction peak is attributed to an ε-iron oxide crystal structure in an X-ray diffraction spectrum obtained by X-ray diffraction analysis, it is determined that the ε-iron oxide crystal structure (F phase) is detected as the main phase. In addition to the F phase of the main phase, an a phase and/or a y phase may or may not be included. An ε-iron oxide powder in the present invention and the present specification includes a so-called non-substitution type ε-iron oxide powder composed of iron and oxygen, and a so-called substitution type ε-iron oxide powder including one or more substituent elements substituting for iron.

### Method of Manufacturing ε-Iron Oxide Powder

As a method of manufacturing an ε-iron oxide powder, a producing method from a goethite, a reverse micelle method, and the like are known. All of the manufacturing methods are well known. Regarding a method of manufacturing an ε-iron oxide powder in which a part of iron is substituted with substituent elements, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example.

As an example, an ε-iron oxide powder contained in a magnetic layer of the magnetic recording medium can be obtained, for example, by a manufacturing method of obtaining an ε-iron oxide powder by preparing a precursor of ε-iron oxide (hereinafter, referred to as a “precursor preparation step”), subjecting the precursor to a coat-forming treatment (hereinafter, referred to as a “coat-forming step”), subjecting the precursor having undergone the coat-forming treatment to a heat treatment, thereby converting the precursor to ε-iron oxide (hereinafter, referred to as a “heat treatment step”), and subjecting the ε-iron oxide to a coat-removing treatment (hereinafter, referred to as a “coat-removing step”). The manufacturing method will be further described below. However, the manufacturing method described below is merely an example, and the ε-iron oxide powder is not limited to those manufactured by the manufacturing method exemplified below.

### Precursor Preparation Step

A precursor of ε-iron oxide refers to a substance that includes an ε-iron oxide crystal structure as a main phase by being heated. The precursor can be, for example, a hydroxide, an oxyhydroxide (oxide hydroxide), or the like containing iron and an element capable of substituting for a part of iron in a crystal structure. The precursor preparation step can be performed by using a coprecipitation method, a reverse micelle method, or the like. A method of preparing such a precursor is well-known, and the precursor preparation step in the above-described manufacturing method can be performed by a well-known method. For example, for the method of preparing the precursor, a well-known technology such as paragraphs 0017 to 0021 of JP2008-174405A and examples thereof, paragraphs 0025 to 0046 of WO2016/047559A1 and examples thereof, paragraphs 0038 to 0040, 0042, 0044, and 0045 of WO2008/149785A1 and examples thereof can be referred to.

ε-Iron oxide, which does not include a substituent element substituting for a part of iron (Fe), can be represented by a composition formula of Fe₂03. On the other hand, ε-iron oxide in which a part of iron is substituted with, for example, one or more types of elements can be represented by a composition formula of A¹ₓA²_{y}A³_{z}Fe_{(2-x-y-z)}O₃. A¹, A², and A³ each independently represent one or more types of substituent elements substituting for iron, and x, y, and z are each independently 0 or more and less than 2, where at least one is more than 0 and x+y+z is less than 2. The ε-iron oxide powder may or may not include a substituent element substituting for iron, and preferably includes a substituent element. A type of a substituent element can be one type or two or more types, and can be one type to three types, one type to four types, one type to five types, or one type to six types. Magnetic properties of an ε-iron oxide powder can be adjusted by a type and a substitution amount of a substituent element. In a case where a substituent element is contained, the substituent element may include one or more of Ga, Al, In, Rh, Mn, Co, Ni, Zn, Ti, Sn, and the like. For example, in the above composition formula, A¹ may be one or more selected from the group consisting of Ga, Al, In, and Rh, and A² may be one or more selected from the group consisting of Co, Mn, Ni, and Zn, and A³ may be one or more selected from the group consisting of Ti and Sn. In one aspect, the ε-iron oxide powder can contain a cobalt element (Co), for example, one or more selected from the group consisting of a cobalt element, a gallium element (Ga), an aluminum element (Al), an indium element (In), and a rhodium element (Rh), and one or more selected from the group consisting of a titanium element (Ti) and a tin element (Sn). In one aspect, the ε-iron oxide powder can contain a cobalt element, a gallium element and/or an aluminum element, and a titanium element. In a case where an ε-iron oxide powder containing a substituent element substituting for iron is manufactured, a part of a compound serving as a supply source of iron in ε-iron oxide need only be substituted with a compound of the substituent element. The composition of an ε-iron oxide powder obtained can be controlled by the substitution amount of the compound. Examples of the compound serving as a supply source of iron and various substituent elements include an inorganic salt (which may be a hydrate) such as a nitrate, a sulfate, and a chloride, an organic salt (which may be a hydrate) such as a pentakis (hydrogen oxalate) salt, a hydroxide, an oxyhydroxide, and the like.

### Coat-Forming Step

In a case where the precursor is heated after the coat-forming treatment, reaction can proceed by which the precursor is converted to ε-iron oxide under the coat. It is considered that the coat can play a role of preventing sintering from occurring during heating. From the viewpoint of ease of forming the coat, the coat-forming treatment is preferably performed in a solution, and more preferably performed by adding a coat-forming agent (compound for forming a coat) to a solution including the precursor. For example, in a case where the coat-forming treatment is performed in the same solution after the preparation of the precursor, by adding the coat-forming agent to the solution after the preparation of the precursor and stirring the solution, a coat can be formed on the precursor. As the coat, for example, a silicon-containing coat is preferable because the coat is easily formed on the precursor in the solution. Examples of the coat-forming agent for forming the silicon-containing coat include a silane compound such as alkoxysilane. Through hydrolysis of the silane compound, a silicon-containing coat can be formed on the precursor, preferably using a sol-gel method. Specific examples of the silane compound include tetraethoxysilane (tetraethyl orthosilicate; TEOS), tetramethoxysilane, and various silane coupling agents. For the coat-forming treatment, for example, a well-known technology such as a paragraph 0022 of JP2008-174405A and examples thereof, paragraphs 0047 to 0049 of WO2016/047559A1 and examples thereof, paragraphs 0041 and 0043 of WO2008/149785A1 and examples thereof can be referred to. For example, the coat-forming treatment can be performed by stirring a solution including a precursor and a coat-forming agent at a liquid temperature of 50° C. to 90° C. The stirring time may be, for example, 5 to 36 hours. The coat may cover the entire surface of the precursor, or a part of the surface of the precursor may not be covered with the coat.

### Heat Treatment Step

By performing a heat treatment on the precursor having undergone the coat-forming treatment, the precursor can be converted to ε-iron oxide. The heat treatment can be performed on, for example, a powder (powder of the precursor having the coat) collected from the solution in which the coat-forming treatment is performed. For the heat treatment step, for example, well-known technology such as a paragraph 0023 of JP2008-174405A and examples thereof, a paragraph 0050 of WO2016/047559A1 and examples thereof, paragraphs 0041 and 0043 of WO2008/149785A1 and examples thereof can be referred to. The heat treatment step can be performed, for example, in a heat treatment furnace having an in-furnace temperature of 900° C. to 1200° C. for about 3 to 6 hours. The higher the temperature of the heat treatment step and/or the longer the heat treatment time, the larger the average particle size of the ε-iron oxide powder obtained tends to be.

### Coat-Removing Step

By performing the heat treatment step, the precursor having the coat can be converted to ε-iron oxide. Since the coat remains on the ε-iron oxide thus obtained, a coat-removing treatment is preferably performed. For the coat-removing treatment, for example, well-known technology such as a paragraph 0025 of JP2008-174405A and examples thereof, a paragraph 0053 of WO2008/149785A1 and examples thereof can be referred to. The coat-removing treatment can be performed, for example, by stirring ε-iron oxide having the coat in a sodium hydroxide aqueous solution having a concentration of about 1 to 5 μmol/L and a liquid temperature of about 60° C. to 90° C. for about 5 to 36 hours. Here, the ε-iron oxide powder contained in the magnetic layer of the magnetic recording medium may be manufactured without performing the coat-removing treatment, or may be such that the coat is not completely removed by the coat-removing treatment and a part of the coat remains.

### Pulverization Step

One or more steps can be optionally executed before and/or after the various steps described above. Examples of such a step include various well-known steps such as classification, filtration, washing, and drying. Further, for example, a pulverization treatment can be executed on the ε-iron oxide powder obtained after drying. Performing the pulverization treatment can contribute to crushing the aggregation of the particles of the ε-iron oxide powder. From the viewpoint of improving the dispersibility of the ε-iron oxide powder, it is preferable to subject the particles of the ε-iron oxide powder to a dispersion treatment described below after crushing the aggregation of the particles of the ε-iron oxide powder. The present inventor supposes that, by increasing the dispersibility of the ε-iron oxide powder, the specific crystal plane of the particles of the ε-iron oxide powder with a strong bonding force with the lubricant can be aligned more parallel to the magnetic layer surface by an electric field application treatment described below. The pulverization treatment can be, for example, a pulverization treatment (mill pulverization) using a mill pulverizer. Treatment conditions for mill pulverization need only be set according to the mill pulverizer to be used, and are not particularly limited. As an example, a rotation speed of the mill pulverizer can be set to 1000 to 20000 rpm (revolutions per minute), a treatment time for one mill pulverization can be set to 0.5 to 10 μminutes, and the number of times of executing the mill pulverization can be set to 1 to 4 times.

### Average Particle Size

From the viewpoint of the magnetization stability, an average particle size of the ε-iron oxide powder contained in the magnetic layer of the magnetic recording medium is preferably 5.0 nm or more, more preferably 6.0 nm or more, still more preferably 7.0 nm or more, still more preferably 8.0 nm or more, and still more preferably 9.0 nm or more. In addition, from the viewpoint of realization of high-density recording, the average particle size of the ε-iron oxide powder is preferably 20.0 nm or less, more preferably 19.0 nm or less, still more preferably 18.0 nm or less, still more preferably 17.0 nm or less, still more preferably 16.0 nm or less, and still more preferably 15.0 nm or less.

In the present invention and the present specification, unless otherwise noted, an average particle size of various powders such as an ε-iron oxide powder is a value measured by the following method using a transmission electron microscope.

The powder is imaged at an imaging magnification of 100000x with a transmission electron microscope, and the image is printed on photographic printing paper or displayed on a display so that the total magnification is 500000x, to obtain an image of particles configuring the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder.

As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software. In the present invention and the present specification, the powder means aggregation of a plurality of particles. For example, a ferromagnetic powder means aggregation of a plurality of ferromagnetic particles. Further, the aggregation of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of collecting sample powder from the magnetic recording medium in order to measure the particle size, a method disclosed in a paragraph 0015 of JP2011-048878A can be adopted, for example.

In the present invention and the present specification, unless otherwise noted, (1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter refers to a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 μmass % and more preferably in a range of 60 to 90 μmass %, with respect to the total mass of the magnetic layer. A high content of the ferromagnetic powder in the magnetic layer is preferable from the viewpoint of improvement of the recording density.

### <<Binding Agent>>

The magnetic recording medium can be a coating type magnetic recording medium, and can include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below.

For the binding agent described above, descriptions disclosed in paragraphs 0028 to 0031 of JP2010-24113A can be referred to. In addition, the binding agent may be a radiation curable resin such as an electron beam curable resin. For the radiation curable resin, descriptions disclosed in paragraphs 0044 and 0045 of JP2011-048878A can be referred to. An average molecular weight of the resin used as the binding agent can be, for example, 10,000 to 200,000 as a weight-average molecular weight. The weight-average molecular weight of the present invention and the present specification is a value obtained by performing polystyrene conversion of a value measured by gel permeation chromatography (GPC) under the following measurement conditions. The weight-average molecular weight of the binding agent shown in Examples described below is a value obtained by performing polystyrene conversion of a value measured under the following measurement conditions. The binding agent may be used in an amount of, for example, 1.0 to 30.0 parts by mass with respect to 100.0 parts by mass of the ferromagnetic powder.
GPC device: HLC-8120 (manufactured by Tosoh Corporation)
Column: TSK gel Multipore HXL-M (manufactured by Tosoh Corporation, 7.8 mm inner diameter (ID)×30.0 cm)
Eluent: Tetrahydrofuran (THF)

A curing agent can also be used together with the resin which can be used as the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. At least a part of the curing agent is contained in the magnetic layer in a state of being reacted (crosslinked) with other components such as the binding agent, by proceeding of the curing reaction in the magnetic layer forming step. The same applies to the layer formed using this composition in a case where the composition used to form the other layer includes a curing agent. The preferred curing agent is a thermosetting compound, polyisocyanate is suitable. For details of the polyisocyanate, descriptions disclosed in paragraphs 0124 and 0125 of JP2011-216149A can be referred to.

The curing agent can be used in a composition for forming a magnetic layer in an amount of, for example, 0 to 80.0 parts by mass, and preferably 10.0 to 80.0 parts by mass, and more preferably 50.0 to 80.0 parts by mass from the viewpoint of improving the strength of the magnetic layer, with respect to 100.0 parts by mass of the binding agent.

The above description regarding the binding agent and the curing agent can also be applied to a non-magnetic layer and/or a back coating layer. In this case, the above description regarding the content can be applied by replacing the ferromagnetic powder with non-magnetic powder.

<<Additive>>

The magnetic layer may include one or more kinds of additives, as necessary. As the additive, a commercially available product can be appropriately selected or manufactured by a well-known method according to the desired properties, and any amount thereof can be used. Examples of the additive include the curing agent described above. In addition, examples of the additive which can be included in the magnetic layer include a non-magnetic powder, a lubricant, a dispersing agent, a dispersing assistant, a fungicide, an antistatic agent, and an antioxidant. For the dispersing agent, descriptions disclosed in paragraphs 0061 and 0071 of JP2012-133837A can be referred to. The dispersing agent may be added to a composition for forming a non-magnetic layer. For the dispersing agent that can be added to the composition for forming a non-magnetic layer, a description disclosed in a paragraph 0061 of JP2012-133837A can be referred to.

Examples of the non-magnetic powder that can be contained in the magnetic layer include a non-magnetic powder that can function as an abrasive. A content of the abrasive in the magnetic layer is preferably 1.0 to 20.0 parts by mass, more preferably 3.0 to 15.0 parts by mass, and still more preferably 4.0 to 10.0 parts by mass with respect to 100.0 parts by mass of the ferromagnetic powder. Examples of the additive that can be used to improve the dispersibility of the abrasive in the magnetic layer containing the abrasive include a dispersing agent disclosed in paragraphs 0012 to 0022 of JP2013-131285A.

Examples of the non-magnetic powder that can be contained in the magnetic layer include a non-magnetic powder (for example, a non-magnetic colloidal particles and carbon black) that can function as a protrusion forming agent which forms protrusions appropriately protruded from the magnetic layer surface. As the protrusion forming agent, for example, a non-magnetic powder having an average particle size of 5 to 300 nm can be used. An average particle size of colloidal silica (silica colloidal particles) shown in Examples described below is a value obtained by a method disclosed as a measurement method of an average particle diameter in a paragraph 0015 of JP2011-048878A. A content of the protrusion forming agent in the magnetic layer is, for example, preferably 0.1 to 3.5 parts by mass, and more preferably 0.1 to 3.0 parts by mass per 100.0 parts by mass of the ferromagnetic powder.

### Lubricant

The magnetic recording medium may include one or more kinds of lubricants in a portion on the magnetic layer side on a non-magnetic support. In the present invention and the present specification, the term “portion on the non-magnetic support on the magnetic layer side” refers to a magnetic layer in a case of a magnetic recording medium including the magnetic layer directly on the non-magnetic support, and refers to a magnetic layer and/or a non-magnetic layer in a case of a magnetic recording medium including the non-magnetic layer between the non-magnetic support and the magnetic layer, which will be described in detail below. The lubricant may include one or more kinds selected from the group consisting of a fatty acid, a fatty acid ester, and a fatty acid amide. As described above, the lubricant can contribute to suppressing the friction of the magnetic recording medium including the magnetic layer containing the ε-iron oxide powder.

Examples of the fatty acid include lauric acid, myristic acid, palmitic acid, stearic acid, oleic acid, linoleic acid, linolenic acid, behenic acid, erucic acid, elaidic acid, stearic acid, myristic acid, and palmitic acid are preferable, and stearic acid is more preferable. The fatty acid may be included in the magnetic layer in a form of a salt such as a metal salt.

Examples of the fatty acid ester include esters of the above-described various fatty acids exemplified for a fatty acid. Specific examples thereof include, for example, butyl myristate, butyl palmitate, butyl stearate, neopentyl glycol dioleate, sorbitan monostearate, sorbitan distearate, sorbitan tristearate, oleyl oleate, isocetyl stearate, isotridecyl stearate, octyl stearate, isooctyl stearate, amyl stearate, and butoxyethyl stearate.

Examples of the fatty acid amide include amides of the above various exemplified fatty acids, specifically, for example, lauric acid amide, myristic acid amide, palmitic acid amide, stearic acid amide, and the like.

For the fatty acid and a derivative of the fatty acid (such as amide and ester), a fatty acid-derived moiety of the fatty acid derivative preferably has a structure which is the same as or similar to that of the fatty acid used in combination. For example, in a case where stearic acid is used as the fatty acid, it is preferable to use stearic acid amide and/or stearic acid ester in combination.

A content of a fatty acid in the composition for forming a magnetic layer is, for example, 0.1 to 10.0 parts by mass, and preferably 1.0 to 7.0 parts by mass per 100.0 parts by mass of the ferromagnetic powder. In a case where two or more different fatty acids are added to the composition for forming a magnetic layer, the content thereof means the total content of two or more different fatty acids. The same applies to other components. In addition, in the present invention and the present specification, unless otherwise noted, a certain component may be used alone or in combination of two or more.

A content of a fatty acid ester in the composition for forming a magnetic layer is, for example, 0 to 10.0 parts by mass, and preferably 1.0 to 7.0 parts by mass per 100.0 parts by mass of the ferromagnetic powder.

A content of a fatty acid amide in the composition for forming a magnetic layer is, for example, 0.1 to 3.0 parts by mass, and preferably 0.1 to 1.0 part by mass per 100.0 parts by mass of the ferromagnetic powder.

On the other hand, the content of the fatty acid in the composition for forming a non-magnetic layer is, for example, 1.0 to 10.0 parts by mass, and preferably 1.0 to 7.0 parts by mass per 100.0 parts by mass of the non-magnetic powder. In addition, the content of the fatty acid ester in the composition for forming a non-magnetic layer is, for example, 0 to 10.0 parts by mass, and preferably 1.0 to 7.0 parts by mass per 100.0 parts by mass of the non-magnetic powder. The content of the fatty acid amide in the composition for forming a non-magnetic layer is, for example, 0.1 to 3.0 parts by mass, and preferably 0.1 to 1.0 part by mass per 100.0 parts by mass of the non-magnetic powder. The non-magnetic layer can play a role of holding a lubricant and supplying the lubricant to the magnetic layer. The lubricant included in the non-magnetic layer may be transferred to the magnetic layer and remain in the magnetic layer.

The magnetic layer described above can be provided on a surface of the non-magnetic support directly or indirectly through the non-magnetic layer.

<Non-Magnetic Layer>

The non-magnetic powder used for the non-magnetic layer may be an inorganic substance powder or an organic substance powder. In addition, carbon black and the like can be used. Examples of the inorganic substance include metal, metal oxide, metal carbonate, metal sulfate, metal nitride, metal carbide, and metal sulfide. These non-magnetic powders can be available as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-24113A can be referred to. The content (filling percentage) of the non-magnetic powder of the non-magnetic layer is preferably in a range of 50 to 90 μmass % and more preferably in a range of 60 to 90 μmass %, with respect to the total mass of the non-magnetic layer.

The non-magnetic layer can include a binding agent, and can also include an additive. For other details of the binding agent or the additive of the non-magnetic layer, a well-known technology regarding the non-magnetic layer can be applied. In addition, in regards to the type and the content of the binding agent, and the type and the content of the additive, for example, a well-known technology regarding the magnetic layer can be applied.

The non-magnetic layer of the present invention and the present specification also includes a substantially non-magnetic layer containing a small amount of ferromagnetic powder as impurities or intentionally, together with the non-magnetic powder. Here, the substantially non-magnetic layer is a layer having a residual magnetic flux density equal to or smaller than 10 μmT, a layer having a coercivity equal to or smaller than 7.96 kA/m (100 Oe), or a layer having a residual magnetic flux density equal to or smaller than 10 μmT and a coercivity equal to or smaller than 7.96 kA/m (100 Oe). It is preferable that the non-magnetic layer does not have a residual magnetic flux density and a coercivity.

<Non-Magnetic Support>

Next, the non-magnetic support will be described. Examples of the non-magnetic support (hereinafter, simply referred to as a “support”) include well-known components such as polyethylene terephthalate, polyethylene naphthalate, polyamide such as aromatic polyamide, and polyamideimide subjected to biaxial stretching. Among these, polyethylene terephthalate, polyethylene naphthalate, and polyamide are preferable. A corona discharge, a plasma treatment, an easy-bonding treatment, or a heat treatment may be performed on these supports in advance.

<Back Coating Layer>

In one aspect, the magnetic recording medium may further include a back coating layer containing a non-magnetic powder on a surface side of the non-magnetic support opposite to a surface side on which the magnetic layer is provided, and in another aspect, the magnetic recording medium may not include a back coating layer. The back coating layer preferably contains any one or both of carbon black and an inorganic powder. The back coating layer can include a binding agent and can also include additives. In regards to the binding agent and the additive of the back coating layer, a well-known technology regarding the back coating layer can be applied, and a well-known technology regarding the formulation of components of the magnetic layer and/or the non-magnetic layer can be applied. For example, for the back coating layer, descriptions disclosed in paragraphs 0018 to 0020 of JP2006-331625A and column 4, line 65 to column 5, line 38 of U.S. Pat. No. 7,029,774B can be referred to.

<Various Thicknesses>
A thickness of the non-magnetic support is preferably 3.0 to 6.0 μm.

From the viewpoint of the high-density recording, which has been required in recent years, a thickness of the magnetic layer is preferably 200 nm or less, more preferably in a range of 8 to 200 nm, and still more preferably in a range of 10 to 200 nm. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 1.5 μm, and preferably 0.1 to 1.0 μm.

A thickness of the back coating layer is preferably 0.9 μm or less and more preferably in a range of 0.1 to 0.7 μm.

Thicknesses of each layer and the non-magnetic support of the magnetic recording medium can be obtained by a well-known film thickness measurement method. As an example, a cross section of the magnetic recording medium in a thickness direction is exposed by a well-known method of ion beams or microtome, and the exposed cross section is observed with a transmission electron microscope or a scanning electron microscope. In the cross section observation, various thicknesses can be obtained as a thickness obtained at one portion of the cross section, or an arithmetic average of thicknesses obtained at a plurality of portions of two or more portions which are randomly extracted. Alternatively, the thickness of each layer may be obtained as a designed thickness calculated under the manufacturing conditions.

<Manufacturing Step>

A step of preparing a composition for forming the magnetic layer, the non-magnetic layer, or the back coating layer can usually include at least a kneading step, a dispersing step, and, as necessary, a mixing step provided before and after these steps. Each step may be divided into two or more stages. Components used for the preparation of a composition for forming each layer may be added at an initial stage or in a middle stage of each step. As a solvent, one or more kinds of various solvents usually used for manufacturing a coating type magnetic recording medium can be used. For the solvent, for example, a description disclosed in a paragraph 0153 of JP2011-216149A can be referred to. In addition, each component can be separately added in two or more steps. In order to manufacture the above magnetic recording medium, a well-known manufacturing technology in the related art can be used in various steps. In the kneading step, an open kneader, a continuous kneader, a pressure kneader, or a kneader having a strong kneading force such as an extruder is preferably used. For details of these kneading processes, JP1989-106338A (JP-HO1-106338A) and JP1989-79274A (JP-HO1-79274A) can be referred to. As a disperser, a well-known disperser can be used. As a dispersion medium, one or more kinds of dispersion beads selected from the group consisting of various dispersion beads can be used. As such dispersion beads, zirconia beads, titania beads, and steel beads which are dispersion beads having high specific gravity are suitable. The present inventor supposes that increasing the dispersibility of the ε-iron oxide powder by enhancing a dispersion treatment in the preparation of the composition for forming a magnetic layer can contribute to the fact that the specific crystal plane of the particles of the ε-iron oxide powder with a strong bonding force with the lubricant can be aligned more parallel to the magnetic layer surface by an electric field application treatment described below. Specific examples of enhancing the dispersion treatment include, for example, prolonging of a dispersion treatment time, reduction of diameter of the dispersion beads used for dispersion, increasing the number of times of the dispersion treatment, and the like. Various dispersion conditions can be set according to a disperser used. As an example, a bead diameter of the dispersion beads can be set to 0.1 to 1.0 mm, the treatment time for one dispersion treatment can be set to 0.5 to 10 hours, and the number of times of the dispersion treatment can be set to 2 times or more. The composition for forming each layer may be filtered by a well-known method before performing the coating step. The filtering can be performed by using a filter, for example. As the filter used in the filtering, a filter having a pore diameter of 0.01 to 3 μm (for example, filter made of glass fiber or filter made of polypropylene) can be used, for example.

The magnetic layer can be formed by directly applying the composition for forming a magnetic layer onto the non-magnetic support or performing multilayer coating of the composition for forming a magnetic layer with the composition for forming a non-magnetic layer in order or at the same time. For details of the coating for forming each layer, a description disclosed in a paragraph 0066 of JP2010-231843A can be referred to.

After the coating step, various treatments such as a drying treatment, an alignment treatment of the magnetic layer, and a surface smoothing treatment (calendering treatment) can be performed. For various treatments, for example, a well-known technology disclosed in paragraphs 0052 to 0057 of JP2010-24113A can be referred to. For example, the coating layer of the composition for forming a magnetic layer can be subjected to an alignment treatment, while the coating layer is wet. For the alignment treatment, various well-known technologies including a description disclosed in a paragraph 0067 of JP2010-231843A can be used. For example, a vertical alignment treatment can be performed by a well-known method such as a method using a polar opposing magnet. In an alignment zone, a drying speed of the coating layer can be controlled depending on a temperature, an air volume of drying air and/or a transportation speed of the non-magnetic support on which the coating layer is formed in the alignment zone. In addition, the coating layer may be preliminarily dried before the transportation to the alignment zone.

Preferably, an electric field application treatment can be performed, while the coating layer of the composition for forming a magnetic layer is wet. The electric field application treatment can be executed, for example, after the alignment treatment. An electric field can be applied perpendicularly to the surface of the coating layer by transporting the non-magnetic support on which the coating layer of the composition for forming a magnetic layer is formed between a pair of facing electrodes. Regarding the arrangement of the electrodes, for example, a positive electrode can be arranged on the magnetic layer side and a negative electrode can be arranged on the other side (for example, the back coating layer side). The applied electric field strength can be, for example, 0.2 to 2.5 kV/mm, and the value of the intensity ratio (Int1/Int2) tends to increase as the value of the applied electric field strength increases. The present inventor supposes that the functional group of the lubricant bonded to the specific crystal plane of the particles of the E-iron oxide powder can be aligned by the electric field by performing the electric field application treatment. The present inventor considers that this can contribute to aligning the specific crystal plane of the particles of the E-iron oxide powder bonded to the lubricant more parallel to the magnetic layer surface.

The magnetic recording medium according to one aspect of the present invention may be a tape-shaped magnetic recording medium (magnetic tape) or a disk-shaped magnetic recording medium (magnetic disk). For example, the magnetic tape is usually accommodated in a magnetic tape cartridge and the magnetic tape cartridge is mounted on a magnetic recording and reproducing device. A servo pattern can also be formed on the magnetic recording medium by a well-known method in order to enable head tracking in the magnetic recording and reproducing device. The term “formation of servo pattern” can also be referred to as “recording of servo signal”. Hereinafter, the formation of the servo patterns will be described using a magnetic tape as an example.

The servo pattern is usually formed along the longitudinal direction of the magnetic tape. Examples of control (servo control) systems using a servo signal include a timing-based servo (TBS), an amplitude servo, and a frequency servo.

As shown in European Computer Manufacturers Association (ECMA)-319 (June 2001), a timing-based servo system is adopted in a magnetic tape based on a linear tape-open (LTO) standard (generally referred to as an “LTO tape”). In this timing-based servo system, the servo pattern is formed by continuously disposing a plurality of pairs of non-parallel magnetic stripes (also referred to as “servo stripes”) in the longitudinal direction of the magnetic tape.

As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo signal continuous in the longitudinal direction of the magnetic tape. A plurality of the servo bands are usually provided on the magnetic tape. For example, in an LTO tape, the number of the servo bands is five. A region interposed between two adjacent servo bands is referred to as a data band. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

As a method for uniquely specifying the servo band, there is a method using a staggered method as shown in ECMA-319 (June 2001). In this staggered method, a group of pairs of non-parallel magnetic stripes (servo stripes) disposed continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding the information in the servo band, a method other than the method described above can be adopted. For example, a predetermined code may be recorded by thinning out a predetermined pair from the group of pairs of servo stripes.

A head for forming a servo pattern is called a servo write head. The servo write head has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. The AC erasing is performed by gradually decreasing an intensity of the magnetic field while reversing a direction of the magnetic field applied to the magnetic tape. Meanwhile, the DC erasing is performed by applying a unidirectional magnetic field to the magnetic tape. The DC erasing further includes two methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. Meanwhile, in a case where a magnetic pattern is transferred to, using the gap, a magnetic tape that has been subjected to horizontal DC erasing, a servo signal obtained by reading the formed servo pattern has a bipolar pulse shape.

The magnetic tape is usually accommodated in a magnetic tape cartridge and the magnetic tape cartridge is mounted in the magnetic recording and reproducing device.

[Magnetic Tape Cartridge]

Another aspect of the present invention relates to a magnetic tape cartridge including the tape-shaped magnetic recording medium (that is, the magnetic tape).

Details of the magnetic tape included in the magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic recording and reproducing device for recording and/or reproducing data on the magnetic tape, the magnetic tape is pulled out of the magnetic tape cartridge to be wound around the reel on the magnetic recording and reproducing device side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic recording and reproducing device side. During this time, data is recorded and/or reproduced as the magnetic head and the surface of the magnetic tape on the magnetic layer side come into contact with each other to be slid on each other. With respect to this, in the dual reel type magnetic tape cartridge, both reels of the supply reel and the winding reel are provided in the magnetic tape cartridge. The magnetic tape cartridge may be any of single reel type magnetic tape cartridge and dual reel type magnetic tape cartridge. The above magnetic tape cartridge need only include the magnetic tape according to one aspect of the present invention, and a well-known technology can be applied to the others. The total length of the magnetic tape accommodated in the magnetic tape cartridge may be, for example, 800 μm or more, and may be in a range of about 800 μm to 2000 μm. It is preferable that the total length of the tape accommodated in the magnetic tape cartridge is long from a viewpoint of increasing the capacity of the magnetic tape cartridge.

[Magnetic Recording and Reproducing Device]

Still another aspect of the present invention relates to a magnetic recording and reproducing device comprising the magnetic recording medium.

In the present invention and the present specification, the term “magnetic recording and reproducing device” means a device capable of performing at least one of the recording of data on the magnetic recording medium or the reproducing of data recorded on the magnetic recording medium. Such a device is generally called a drive.

In the above-described magnetic recording and reproducing device, in one aspect, the magnetic recording medium is treated as a removable medium (so-called replaceable medium). In such an aspect, for example, the magnetic tape cartridge accommodating the magnetic tape is inserted into the magnetic recording and reproducing device and taken out. That is, in one aspect, the magnetic recording and reproducing device can attachably and detachably include the magnetic tape cartridge. In another aspect, the magnetic recording medium is not treated as a replaceable medium, and the magnetic head and the magnetic recording medium are accommodated in the magnetic recording and reproducing device. In such an aspect, for example, the magnetic tape is accommodated in a reel in the magnetic recording and reproducing device comprising the magnetic head by being wound.

The magnetic recording and reproducing device can be, for example, a sliding type magnetic recording and reproducing device. The sliding type magnetic recording and reproducing device is a device in which the surface on the magnetic layer side and the magnetic head come into contact with each other to be slid on each other, in a case of performing recording of data on the magnetic recording medium and/or reproducing of the recorded data.

The magnetic recording and reproducing device may include a magnetic head. The magnetic head can be a recording head capable of performing the recording of data on the magnetic recording medium, and can also be a reproducing head capable of performing the reproducing of data recorded on the magnetic recording medium. In addition, in one aspect, the magnetic recording and reproducing device can include both a recording head and a reproducing head as separate magnetic heads. In another aspect, the magnetic head included in the magnetic recording and reproducing device can have a configuration in which both an element for recording data (recording element) and an element for reproducing data (reproducing element) are included in one magnetic head. Hereinafter, the element for recording data and the element for reproducing are collectively referred to as “elements for data”. As the reproducing head, a magnetic head (MR head) including a magnetoresistive (MR) element capable of sensitively reading data recorded on the magnetic tape as a reproducing element is preferable. As the MR head, various well-known MR heads such as an Anisotropic Magnetoresistive (AMR) head, a Giant Magnetoresistive (GMR) head, or a Tunnel Magnetoresistive (TMR) head can be used. In addition, the magnetic head which performs the recording of data and/or the reproducing of data may include a servo signal reading element. Alternatively, as a head other than the magnetic head which performs the recording of data and/or the reproducing of data, a magnetic head (servo head) comprising a servo signal reading element may be included in the magnetic recording and reproducing device. For example, a magnetic head that records data and/or reproduces recorded data (hereinafter also referred to as “recording and reproducing head”) can include two servo signal reading elements, and the two servo signal reading elements can simultaneously read two adjacent servo bands. One or a plurality of elements for data can be disposed between the two servo signal reading elements.

In the magnetic recording and reproducing device, recording of data on the magnetic recording medium and/or reproducing of data recorded on the magnetic recording medium can be performed, for example, as the surface of the magnetic recording medium on the magnetic layer side and the magnetic head come into contact with each other to be slid on each other. The magnetic recording and reproducing device need only include the magnetic recording medium according to one aspect of the present invention, and a well-known technology can be applied to the others.

For example, in a case of recording data and/or reproducing recorded data, first, tracking using the servo signal is performed. That is, by causing the servo signal reading element to follow a predetermined servo track, the element for data is controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

### EXAMPLES

Hereinafter, the present invention will be described based on Examples. Note that the present invention is not limited to the embodiments shown in Examples. “Parts” and “%” in the following description mean “parts by mass” and “mass %”, unless otherwise specified. “eq” indicates equivalent and is a unit not convertible into SI unit. The steps and evaluations in the following description were performed in an environment of an atmosphere temperature of 23° C.±1° C., unless otherwise noted.

### Example 1

<Production of Ferromagnetic Powder No. 1>

Iron(III) nitrate nonahydrate (added amount: “amount of Fe nitrate” in Table 1), gallium(III) nitrate octahydrate (added amount: “amount of Ga nitrate” in Table 1), cobalt(II) nitrate hexahydrate (added amount: “amount of Co nitrate” in Table 1), titanium(IV) sulfate (added amount: “amount of Ti sulfate” in Table 1), and 16.7 g of polyvinylpyrrolidone (PVP) were dissolved in 90 g of pure water, and while the dissolved product was stirred using a magnetic stirrer, 44.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid aqueous solution obtained by dissolving 11 g of citric acid in 100 g of pure water was added to the obtained solution and stirred for 1 hour. The powder sedimented after stirring was collected by centrifugal separation, was washed with pure water, and was dried in a heating furnace at an in-furnace temperature of 80° C.

8900 g of pure water was added to the dried powder, and the powder was dispersed again in water to obtain dispersion liquid. The obtained dispersion liquid was heated to a liquid temperature of 50° C., and 440 g of an aqueous ammonia solution having a concentration of 25% was dropwise added with stirring. After stirring for 1 hour while maintaining the temperature at 50° C., 160 μmL of tetraethoxysilane (TEOS) was dropwise added and was stirred for 24 hours. A powder sedimented by adding 500 g of ammonium sulfate to the obtained reaction solution was collected by centrifugal separation, was washed with pure water, and was dried in a heating furnace at an in-furnace temperature of 80° C. for 24 hours to obtain a ferromagnetic powder precursor.

The obtained ferromagnetic powder precursor was loaded into a heating furnace at an in-furnace temperature shown in Table 1 in an air atmosphere and was heat-treated for 4 hours.

The heat-treated powder was put into a 4 μmol/L sodium hydroxide (NaOH) aqueous solution, and the mixture was stirred for 24 hours while maintaining the liquid temperature at 75° C. to perform the coat-removing step.

Thereafter, the ferromagnetic powder after the coat-removing step was collected by centrifugal separation, was washed with pure water, and was dried in a heating furnace at an in-furnace temperature of 95° C. After drying, a mill pulverizing step was executed under the conditions shown in Table 1 with an absolute mill (ABS-W manufactured by Osaka Chemical Co., Ltd.).

Composition confirmation of Ferromagnetic powder No. 1 obtained through the above steps was performed by high-frequency inductively coupled plasma-optical emission spectrometry (ICP-OES), and it was confirmed to be substitution type ε-iron oxide having the composition shown in Table 1. Values shown in Table 1 for the composition are the number ((2-x-y-z), x, y, z) of each element in a composition formula: A¹ₓA²_{y}A³_{z}Fe_{(2-x-y-z)}O₃. In addition, scanning with CuKa rays was performed under conditions of a voltage of 45 kV and an intensity of 40 μmA, an X-ray diffraction pattern was measured under the following conditions (X-ray diffraction analysis), and it was confirmed from a peak of the X-ray diffraction pattern that the obtained ferromagnetic powder had an F phase crystal structure of a single phase (s-iron oxide crystal structure) not including a phase and y phase crystal structures.
PANalytical X'Pert Pro diffractometer, PIXcel detector
Soller slit of incident beam and diffraction beam: 0.017 radians
Fixed angle of dispersion slit: ¼ degrees
Mask: 10 mm
Anti-scattering slit: ¼ degrees
Measurement mode: continuous
Measurement time per stage: 3 seconds
Measurement speed: 0.017 degrees per second
Measurement step: 0.05 degrees

<Production of Magnetic Tape>

<<Composition for forming a magnetic layer>>
(Magnetic Liquid)
ε-Iron oxide powder (ferromagnetic powder shown in Table 1): 100.0 parts
Sulfonic acid group-containing polyurethane resin: 15.0 parts
Cyclohexanone: 150.0 parts
Methyl ethyl ketone: 150.0 parts
(Abrasive Solution)
α-Alumina (average particle size: 110 nm): 9.0 parts
Vinyl chloride copolymer (MR110 manufactured by Kaneka Corporation): 0.7 parts
Cyclohexanone: 20.0 parts
(Protrusion Forming Agent Liquid)
Colloidal silica (average particle size: 100 nm): 1.3 parts
Methyl ethyl ketone: 9.0 parts
Cyclohexanone: 6.0 parts
(Other Components)
Lubricant: See Table 1 for type and amount
Polyisocyanate (CORONATE manufactured by Tosoh Corporation): 2.5 parts
(Finishing Additive Solvent)
Cyclohexanone: 180.0 parts
Methyl ethyl ketone: 180.0 parts

<<Composition for forming a non-magnetic layer>>
Non-magnetic inorganic powder (α-iron oxide): 80.0 parts
(average particle size: 0.15 μm, average acicular ratio: 7, brunauer-emmett-teller (BET) specific surface area: 52 m²/g)
Carbon black (average particle size: 20 nm): 20.0 parts
Electron beam curable vinyl chloride copolymer: 13.0 parts
Electron beam curable polyurethane resin: 6.0 parts
Phenylphosphonic acid: 3.0 parts
Cyclohexanone: 140.0 parts
Methyl ethyl ketone: 170.0 parts
Butyl stearate: 4.0 parts
Stearic acid: 1.0 part

<Composition for Forming Back Coating Layer>
Non-magnetic inorganic powder (α-iron oxide): 80.0 parts
(average particle size: 0.15 μm, average acicular ratio: 7, BET specific surface area: 52 m²/g)
Carbon black (average particle size: 20 nm): 20.0 parts
Carbon black (average particle size: 100 nm): 3.0 parts
Vinyl chloride copolymer: 13.0 parts
Sulfonic acid group-containing polyurethane resin: 6.0 parts
Phenylphosphonic acid: 3.0 parts
Cyclohexanone: 140.0 parts
Methyl ethyl ketone: 170.0 parts
Stearic acid: 3.0 parts
Polyisocyanate (CORONATE manufactured by Tosoh Corporation): 5.0 parts
Methyl ethyl ketone: 400.0 parts

<<Preparation of Composition for Forming Each Layer>>
A composition for forming a magnetic layer was prepared by the following method.
A magnetic liquid was prepared by dispersing various components of the magnetic liquid. The dispersion treatment was executed using a batch type vertical sand mill with the dispersion treatment conditions of the first pass and the second pass as the conditions shown in Table 1. Zirconia beads were used as the dispersion beads.

After mixing various components of the above-described abrasive solution, the mixture was put into a vertical sand mill disperser together with zirconia beads having a bead diameter of 1 mm, a ratio of the bead volume to the total of the abrasive solution volume and the bead volume was adjusted to be 60%, and subjected to a sand mill dispersion treatment for 180 μminutes. The liquid after the sand mill dispersion treatment was taken out and subjected to an ultrasonic dispersion filtration treatment using a flow type ultrasonic dispersion filtration device to prepare an abrasive solution.

The magnetic liquid, the abrasive solution, the protrusion forming agent liquid, other components, and the finishing additive solvent were introduced into a dissolver stirrer, and the mixture was stirred at a circumferential speed of 10 m/sec for 30 μminutes. After that, a dispersion treatment of 2 passes was performed at a flow rate of 7.5 kg/min by a flow type ultrasonic disperser, and then the obtained liquid was filtered once through a filter having a pore diameter of 1.0 μm. Thereby, a composition for forming a magnetic layer was prepared.

A composition for forming a non-magnetic layer was prepared by the following method.

The components excluding a lubricant (butyl stearate and stearic acid) were kneaded and diluted by an open kneader, and then subjected to a dispersion treatment by a horizontal beads mill disperser. After that, the lubricant (butyl stearate and stearic acid) was added into the obtained dispersion liquid and stirred and mixed by a dissolver stirrer to prepare a composition for forming a non-magnetic layer.

A composition for forming a back coating layer was prepared by the following method.

The components excluding a lubricant (stearic acid), polyisocyanate, and methyl ethyl ketone (400.0 parts) were kneaded and diluted by an open kneader, and then subjected to a dispersion treatment by a horizontal beads mill disperser. After that, the lubricant (stearic acid), polyisocyanate, and methyl ethyl ketone (400.0 parts) were added into the obtained dispersion liquid and stirred and mixed by a dissolver stirrer to prepare a composition for forming a back coating layer.

<<Production of Magnetic Tape>>

The composition for forming a non-magnetic layer was applied onto a surface of a biaxially stretched polyethylene naphthalate support having a thickness of 5.0 μm and dried so that the thickness after drying was 1.0 μm, and then, an electron beam was emitted at an acceleration voltage of 125 kV to obtain an energy of 40 kGy. A composition for forming a magnetic layer was applied thereonto so that the thickness after drying was 50 nm, to form a coating layer. While the coating layer is wet, a vertical alignment treatment was performed by applying a magnetic field having a magnetic field intensity of 0.6 T in an alignment zone in a direction perpendicular to a surface of the coating layer. Immediately after that, an electric field having the electric field strength shown in Table 1 was applied perpendicularly to the surface of the coating layer by the positive electrode arranged on the coating layer side and the negative electrode arranged on the opposite side, and then dried. Thereby, a magnetic layer was formed. Thereafter, the composition for forming a back coating layer was applied onto a surface of the support opposite to the surface on which the non-magnetic layer and the magnetic layer are formed, so that the thickness after drying was 0.5 μm, and dried. Thereby, a back coating layer was formed.

After that, a surface smoothing treatment (calendering treatment) was performed using a calender roll formed of only metal rolls at a calendering treatment speed of 80 μm/min, a linear pressure of 300 kg/cm (294 kN/m), and a surface temperature of the calender roll of 110° C.

After that, a heat treatment was performed for 36 hours in an environment of an atmosphere temperature of 70° C. After the heat treatment, the resultant was slit to have ½ inches (0.0127 meters) width, and the magnetic layer surface was cleaned with a tape cleaning device in which a non-woven fabric and a razor blade are attached to a device including a feeding and winding device of the slit so as to press the magnetic layer surface. After that, in a state where the magnetic layer of the magnetic tape was demagnetized, a servo pattern having disposition and a shape according to the linear tape-open (LTO) Ultrium format was formed on the magnetic layer by using a servo write head mounted on a servo writer. In this way, a magnetic tape including a data band, a servo band, and a guide band in the disposition according to the LTO Ultrium format in the magnetic layer and including a servo pattern having the disposition and the shape according to the LTO Ultrium format on the servo band was obtained.

### Examples 2 to 12 and Comparative Examples 1 to 6

A ferromagnetic powder was produced and a magnetic tape was produced by the same method described for Example 1, except that items shown in Table 1 were changed as shown in Table 1. Regarding Ferromagnetic powder No. 8, “amount of Al nitrate” in Table 1 indicates an amount of aluminum(III) nitrate nonahydrate. In Table 1, for Comparative Examples in which “0.0” was indicated in the row of electric field strength, the electric field application treatment was not executed during the production of the magnetic tape.

Composition confirmation of the ferromagnetic powders No. 2 to No. 12 in Table 1 was also performed by ICP-OES, and it was confirmed that the ferromagnetic powders No. 2 to No. 8 and No. 10 to No. 12 were substitution type ε-iron oxide having the composition shown in Table 1, and that the ferromagnetic powder No. 9 was non-substitution type ε-iron oxide. In addition, scanning with CuKa rays was performed under conditions of a voltage of 45 kV and an intensity of 40 μmA, an X-ray diffraction pattern was measured under the conditions described above (X-ray diffraction analysis), and it was confirmed from a peak of the X-ray diffraction pattern that the obtained ferromagnetic powder had an F phase crystal structure of a single phase (s-iron oxide crystal structure) not including a phase and y phase crystal structures.

An average particle size of Ferromagnetic powders described above was obtained by the method described above using transmission electron microscope H-9000 manufactured by Hitachi, Ltd. as a transmission electron microscope, and using image analysis software KS-400 manufactured by Carl Zeiss as image analysis software. The obtained average particle size is shown in Table 1 as a ferromagnetic powder size.

### Evaluation Method

<Intensity Ratio (Int1/Int2)>

A tape sample was cut out from the produced magnetic tape.

Regarding the cut-out tape sample, the magnetic layer surface was irradiated with X-ray by using a thin-film X-ray diffractometer (SmartLab manufactured by Rigaku Corporation), and the In-Plane XRD was performed by the method described above. Int1 and Int2 were obtained from the X-ray diffraction spectrum obtained by the In-Plane XRD, and the intensity ratio (Int1/Int2) was calculated from the obtained values.

<Friction Evaluation>

A tape sample having a tape length of 50 μm was cut out from the produced magnetic tape.

In an environment of an atmosphere temperature of 32° C.±1° C. and a relative humidity of 80%, a magnetic recording and reproducing head (hereinafter, simply referred to as a “head”) removed from a linear tape-open generation 6 (LTO (registered trademark) G6) drive manufactured by IBM Corporation was attached to a tape running system. In this tape running system, the tape was subjected to running of 10000 cycles by a method of feeding the tape sample from a feeding roll while applying a tension of 0.6 N(Newton) in the longitudinal direction of the tape, running at 10 m/sec, and winding the tape sample around a winding roll. A strain gauge was attached to the head to monitor a voltage value obtained during sliding between the magnetic layer surface and the head, and, in a case where the voltage value exceeded a predetermined voltage value, it was determined that sticking is generated. Here, a direction toward the other end part with reference to one end part of the magnetic tape is referred to as an inner side, and a region having a length of 5 m from a position of 5 m to a position of 10 m toward the inner side from the magnetic tape end part is defined as an acceleration region. The number of times of sticking was counted for a region having a total length of 10 m, that is, an acceleration region on one end part side and an acceleration region on the other end part side of the magnetic tape. In a case where the sticking is performed 5 times or less during the running of 10000 cycles, it can be evaluated that the magnetic tape has a performance capable of meeting the strict needs in the future.

The above results are shown in Table 1 (Tables 1-1 to 1-3).

TABLE 1-1

| | | | Unit | Example 1 | Example 2 | Example 3 |
|---|---|---|---|---|---|---|
| Ferromagnetic | Ferromagnetic powder No. | | — | 1 | 2 | 2 |
| powder | Raw | Amount of | g | 92.2 | 92.2 | 92.2 |
| | material | Fe nitrate | | | | |
| | | Amount of | g | 14.4 | 14.4 | 14.4 |
| | | Ga nitrate | | | | |
| | | Amount of | g | 0.0 | 0.0 | 0.0 |
| | | Al nitrate | | | | |
| | | Amount of | g | 2.1 | 2.1 | 2.1 |
| | | Co nitrate | | | | |
| | | Amount of | g | 1.7 | 1.7 | 1.7 |
| | | Ti sulfate | | | | |
| | Composition | | — | Fe:Ga:Co:Ti | Fe:Ga:Co:Ti | Fe:Ga:Co:Ti |
| | | | | 1.62:0.28:0.05:0.05 | 1.62:0.28:0.05:0.05 | 1.62:0.28:0.05:0.05 |
| | In-furnace temperature | | ° C. | 1000 | 1000 | 1020 |
| | during heat treatment | | | | | |
| | 1st | Rotation | rpm | 5000 | 5000 | 5000 |
| | pulverization | speed | | | | |
| | | Time | Minutes | 2 | 3 | 4 |
| | 2nd | Rotation | rpm | 10000 | 10000 | 10000 |
| | pulverization | speed | | | | |
| | | Time | Minutes | 1 | 2 | 2 |
| | Ferromagnetic powder | | nm | 11.5 | 11.4 | 11.4 |
| | size | | | | | |
| Lubricant in | Stearic acid | | Parts | 1.0 | 1.0 | 1.0 |
| composition | Butyl stearate | | Parts | 1.0 | 1.0 | 1.0 |
| for forming | Stearic acid amide | | Parts | — | — | — |
| magnetic layer | | | | | | |
| Dispersion | 1st pass | Bead | mm | 0.5 | 0.5 | 0.5 |
| condition | | diameter | | | | |
| | | Time | Hours | 3 | 3 | 5 |
| | 2nd pass | Bead | mm | 0.3 | 0.3 | 0.3 |
| | | diameter | | | | |
| | | Time | Hours | 3 | 3 | 5 |
| Electric field | Electric field strength | | kV/mm | 1.0 | 1.2 | 1.4 |
| application | | | | | | |
| treatment | | | | | | |
| Evaluation | Intensity ratio (Int1/Int2) | | — | 3.6 | 5.1 | 6.5 |
| result | Friction | | Times | 1 | 1 | 5 |
| | | | Unit | Example 4 | Example 5 | Example 6 |
| Ferromagnetic | Ferromagnetic powder No. | | — | 3 | 3 | 4 |
| powder | Raw | Amount of | g | 92.2 | 92.2 | 92.2 |
| | material | Fe nitrate | | | | |
| | | Amount of | g | 14.4 | 14.4 | 14.4 |
| | | Ga nitrate | | | | |
| | | Amount of | g | 0.0 | 0.0 | 0.0 |
| | | Al nitrate | | | | |
| | | Amount of | g | 2.1 | 2.1 | 2.1 |
| | | Co nitrate | | | | |
| | | Amount of | g | 1.7 | 1.7 | 1.7 |
| | | Ti sulfate | | | | |
| | Composition | | — | Fe:Ga:Co:Ti | Fe:Ga:Co:Ti | Fe:Ga:Co:Ti |
| | | | | 1.62:0.28:0.05:0.05 | 1.62:0.28:0.05:0.05 | 1.62:0.28:0.05:0.05 |
| | In-furnace temperature | | ° C. | 1015 | 1020 | 1020 |
| | during heat treatment | | | | | |
| | 1st | Rotation | rpm | 5000 | 5000 | 5000 |
| | pulverization | speed | | | | |
| | | Time | Minutes | 1 | 1 | 2 |
| | 2nd | Rotation | rpm | 10000 | 10000 | 10000 |
| | pulverization | speed | | | | |
| | | Time | Minutes | 1 | 0.5 | 1 |
| | Ferromagnetic powder | | nm | 11.8 | 11.8 | 14.2 |
| | size | | | | | |
| Lubricant in | Stearic acid | | Parts | 1.0 | 1.0 | 1.0 |
| composition | Butyl stearate | | Parts | 1.0 | 1.0 | 1.0 |
| for forming | Stearic acid amide | | Parts | — | — | — |
| magnetic layer | | | | | | |
| Dispersion | 1st pass | Bead | mm | 0.5 | 0.5 | 0.5 |
| condition | | diameter | | | | |
| | | Time | Hours | 3 | 2 | 3 |
| | 2nd pass | Bead | mm | 0.3 | 0.3 | 0.3 |
| | | diameter | | | | |
| | | Time | Hours | 3 | 2 | 3 |

| | | | | | |
|---|---|---|---|---|---|
| Electric field | Electric field strength | kV/mm | 0.8 | 0.6 | 1.0 |
| application | | | | | |
| treatment | | | | | |
| Evaluation | Intensity ratio (Int1/Int2) | — | 2.5 | 1.0 | 3.9 |
| result | Friction | Times | 3 | 5 | 1 |

TABLE 1-2

| | | | Unit | Example 7 | Example 8 | Example 9 |
|---|---|---|---|---|---|---|
| Ferromagnetic | Ferromagnetic powder No. | | — | 5 | 6 | 7 |
| powder | Raw | Amount of | g | 92.2 | 103.0 | 89.4 |
| | material | Fe nitrate | | | | |
| | | Amount of | g | 14.4 | 7.7 | 22.1 |
| | | Ga nitrate | | | | |
| | | Amount of | g | 0.0 | 0.0 | 0.0 |
| | | Al nitrate | | | | |
| | | Amount of | g | 2.1 | 0.8 | 0.0 |
| | | Co nitrate | | | | |
| | | Amount of | g | 1.7 | 0.7 | 0.0 |
| | | Ti sulfate | | | | |
| | Composition | | — | Fe:Ga:Co:Ti | Fe:Ga:Co:Ti | Fe:Ga:Co:Ti |
| | | | | 1.62:0.28:0.05:0.05 | 1.81:0.15:0.02:0.02 | 1.57:0.43:0:0 |
| | In-furnace temperature | | ° C. | 980 | 1000 | 1000 |
| | during heat treatment | | | | | |
| | 1st | Rotation | rpm | 5000 | 5000 | 5000 |
| | pulverization | speed | | | | |
| | | Time | Minutes | 2 | 2 | 2 |
| | 2nd | Rotation | rpm | 10000 | 10000 | 10000 |
| | pulverization | speed | | | | |
| | | Time | Minutes | 1 | 1 | 1 |
| | Ferromagnetic powder | | nm | 9.8 | 11.7 | 11.5 |
| | size | | | | | |
| Lubricant in | Stearic acid | | Parts | 1.0 | 1.0 | 1.0 |
| composition | Butyl stearate | | Parts | 1.0 | 1.0 | 1.0 |
| for forming | Stearic acid amide | | Parts | — | — | — |
| magnetic layer | | | | | | |
| Dispersion | 1st pass | Bead | mm | 0.5 | 0.5 | 0.5 |
| condition | | diameter | | | | |
| | | Time | Hours | 3 | 3 | 3 |
| | 2nd pass | Bead | mm | 0.3 | 0.3 | 0.3 |
| | | diameter | | | | |
| | | Time | Hours | 3 | 3 | 3 |

| | | | | | |
|---|---|---|---|---|---|
| Electric field | Electric field strength | kV/mm | 1.0 | 1.0 | 1.0 |
| application | | | | | |
| treatment | | | | | |
| Evaluation | Intensity ratio (Int1/Int2) | — | 3.3 | 3.7 | 4.0 |
| result | Friction | Times | 1 | 1 | 1 |

| | | | Unit | Example 10 | Example 11 | Example 12 |
|---|---|---|---|---|---|---|
| Ferromagnetic | Ferromagnetic powder No. | | — | 8 | 9 | 1 |
| powder | Raw | Amount of | g | 92.8 | 113.8 | 92.2 |
| | material | Fe nitrate | | | | |
| | | Amount of | g | 0.0 | 0.0 | 14.4 |
| | | Ga nitrate | | | | |
| | | Amount of | g | 13.0 | 0.0 | 0.0 |
| | | Al nitrate | | | | |
| | | Amount of | g | 2.1 | 0.0 | 2.1 |
| | | Co nitrate | | | | |
| | | Amount of | g | 1.7 | 0.0 | 1.7 |
| | | Ti sulfate | | | | |
| | Composition | | — | Fe:Al:Co:Ti | Fe:Ga:Co:Ti | Fe:Ga:Co:Ti |
| | | | | 1.63:0.27:0.05:0.05 | 2.00:0:0:0 | 1.62:0.28:0.05:0.05 |
| | In-furnace temperature | | ° C. | 1000 | 1000 | 1000 |
| | during heat treatment | | | | | |
| | 1st | Rotation | rpm | 5000 | 5000 | 5000 |
| | pulverization | speed | | | | |
| | | Time | Minutes | 2 | 2 | 2 |
| | 2nd | Rotation | rpm | 10000 | 10000 | 10000 |
| | pulverization | speed | | | | |
| | | Time | Minutes | 1 | 1 | 1 |
| | Ferromagnetic powder | | nm | 11.5 | 11.4 | 11.5 |
| | size | | | | | |
| Lubricant in | Stearic acid | | Parts | 1.0 | 1.0 | — |
| composition | Butyl stearate | | Parts | 1.0 | 1.0 | 1.0 |
| for forming | Stearic acid amide | | Parts | — | — | 1.0 |
| magnetic layer | | | | | | |
| Dispersion | 1st pass | Bead | mm | 0.5 | 0.5 | 0.5 |
| condition | | diameter | | | | |
| | | Time | Hours | 3 | 3 | 3 |
| | 2nd pass | Bead | mm | 0.3 | 0.3 | 0.3 |
| | | diameter | | | | |
| | | Time | Hours | 3 | 3 | 3 |

| | | | | | |
|---|---|---|---|---|---|
| Electric field | Electric field strength | kV/mm | 1.0 | 1.0 | 1.0 |
| application | | | | | |
| treatment | | | | | |
| Evaluation | Intensity ratio (Int1/Int2) | — | 3.2 | 4.1 | 3.4 |
| result | Friction | Times | 1 | 1 | 1 |

TABLE 1-3

| | | | | Comparative | Comparative | Comparative |
|---|---|---|---|---|---|---|
| | | | Unit | Example 1 | Example 2 | Example 3 |
| Ferromagnetic | Ferromagnetic powder No. | | — | 1 | 1 | 10 |
| powder | Raw | Amount of | g | 92.2 | 92.2 | 92.2 |
| | material | Fe nitrate | | | | |
| | | Amount of | g | 14.4 | 14.4 | 14.4 |
| | | Ga nitrate | | | | |
| | | Amount of | g | 0.0 | 0.0 | 0.0 |
| | | Al nitrate | | | | |
| | | Amount of | g | 2.1 | 2.1 | 2.1 |
| | | Co nitrate | | | | |
| | | Amount of | g | 1.7 | 1.7 | 1.7 |
| | | Ti sulfate | | | | |
| | Composition | | Fe:Ga:Co:Ti | 1.62:0.28:0.05:0.05 | 1.62:0.28:0.05:0.05 | 1.62:0.28:0.05:0.05 |
| | In-furnace temperature | | ° C. | 1000 | 1000 | 1000 |
| | during heat treatment | | | | | |
| | 1st | Rotation | rpm | 5000 | 5000 | — |
| | pulverization | speed | | | | |
| | | Time | Minutes | 2 | 2 | — |
| | 2nd | Rotation | rpm | 10000 | 10000 | — |
| | pulverization | speed | | | | |
| | | Time | Minutes | 1 | 1 | — |
| | Ferromagnetic powder | | nm | 11.5 | 11.5 | 11.7 |
| | size | | | | | |
| Lubricant in | Stearic acid | | Parts | 1.0 | 1.0 | 1.0 |
| composition | Butyl stearate | | Parts | 1.0 | 1.0 | 1.0 |
| for forming | Stearic acid amide | | Parts | — | — | — |
| magnetic layer | | | | | | |
| Dispersion | 1st pass | Bead | mm | 0.5 | 0.5 | 0.5 |
| condition | | diameter | | | | |
| | | Time | Hours | 3 | 3 | 3 |
| | 2nd pass | Bead | mm | 0.3 | — | 0.3 |
| | | diameter | | | | |
| | | Time | Hours | 3 | — | 3 |
| Electric field | Electric field strength | | kV/mm | 0.0 | 1.0 | 1.0 |
| application | | | | | | |
| treatment | | | | | | |
| Evaluation | Intensity ratio (Int1/Int2) | | — | 0.7 | 0.8 | 0.8 |
| result | Friction | | Times | 24 | 23 | 25 |
| | | | | Comparative | Comparative | Comparative |
| | | | Unit | Example 4 | Example 5 | Example 6 |
| Ferromagnetic | Ferromagnetic powder No. | | — | 10 | 11 | 12 |
| powder | Raw | Amount of | g | 92.2 | 92.2 | 93.2 |
| | material | Fe nitrate | | | | |
| | | Amount of | g | 14.4 | 14.4 | 14.4 |
| | | Ga nitrate | | | | |
| | | Amount of | g | 0.0 | 0.0 | 0.0 |
| | | Al nitrate | | | | |
| | | Amount of | g | 2.1 | 2.1 | 2.1 |
| | | Co nitrate | | | | |
| | | Amount of | g | 1.7 | 1.7 | 1.7 |
| | | Ti sulfate | | | | |
| | Composition | | Fe:Ga:Co:Ti | 1.62:0.28:0.05:0.05 | 1.62:0.28:0.05:0.05 | 1.62:0.28:0.05:0.05 |
| | In-furnace temperature | | ° C. | 1000 | 1000 | 1000 |
| | during heat treatment | | | | | |
| | 1st | Rotation | rpm | — | 5000 | 5000 |
| | pulverization | speed | | | | |
| | | Time | Minutes | — | 4 | 1 |
| | 2nd | Rotation | rpm | — | 10000 | 10000 |
| | pulverization | speed | | | | |
| | | Time | Minutes | — | 3 | 0.5 |
| | Ferromagnetic powder | | nm | 11.7 | 9.8 | 11.7 |
| | size | | | | | |
| Lubricant in | Stearic acid | | Parts | 1.0 | 1.0 | 1.0 |
| composition | Butyl stearate | | Parts | 1.0 | 1.0 | 1.0 |
| for forming | Stearic acid amide | | Parts | — | — | — |
| magnetic layer | | | | | | |
| Dispersion | 1st pass | Bead | mm | 0.5 | 0.5 | 0.5 |
| condition | | diameter | | | | |
| | | Time | Hours | 5 | 6 | 2 |
| | 2nd pass | Bead | mm | — | 0.3 | 0.3 |
| | | diameter | | | | |
| | | Time | Hours | — | 6 | 2 |

| | | | | | |
|---|---|---|---|---|---|
| Electric field | Electric field strength | kV/mm | 0.0 | 1.6 | 0.4 |
| application | | | | | |
| treatment | | | | | |
| Evaluation | Intensity ratio (Int1/Int2) | — | 0.7 | 6.7 | 0.9 |
| result | Friction | Times | 35 | 15 | 15 |

From the results shown in Table 1, it can be confirmed that the friction during sliding between the magnetic layer surface and the magnetic head is suppressed in the magnetic tapes of Examples as compared with the magnetic tapes of Comparative Examples.

One aspect of the present invention is effective in data storage applications.

What is claimed is:

1. A magnetic recording medium comprising:
a non-magnetic support; and
a magnetic layer containing a ferromagnetic powder,
wherein the ferromagnetic powder is an ε-iron oxide powder,
Int1/Int2, which is an intensity ratio of diffraction intensities obtained by an X-ray diffraction analysis of the magnetic layer using an In-Plane method, is 1.0 or more and 6.5 or less,
the Int1 is a maximum value of a diffraction intensity in a range in which a diffraction angle2θ_{χ} is 29.0° or more and 31.0° or less, and
the Int2 is a maximum value of a diffraction intensity in a range in which the diffraction angle2θ_{χ} is 36.3° or more and 37.5° or less.

2. The magnetic recording medium according to claim 1,
wherein the intensity ratio is 1.5 or more and 6.0 or less.

3. The magnetic recording medium according to claim 1,
wherein the intensity ratio is 3.0 or more and 5.5 or less.

4. The magnetic recording medium according to claim 1,
wherein the ε-iron oxide powder contains a cobalt element.

5. The magnetic recording medium according to claim 4,
wherein the ε-iron oxide powder further contains an element selected from the group consisting of a gallium element and an aluminum element.

6. The magnetic recording medium according to claim 4,
wherein the ε-iron oxide powder further contains a titanium element.

7. The magnetic recording medium according to claim 1, further comprising:
a non-magnetic layer containing a non-magnetic powder between the non-magnetic support and the magnetic layer.

8. The magnetic recording medium according to claim 1, further comprising:
a back coating layer containing a non-magnetic powder on a surface side of the non-magnetic support opposite to a surface side on which the magnetic layer is provided.

9. The magnetic recording medium according to any claim 1,
wherein the magnetic recording medium is a magnetic tape.

10. A magnetic tape cartridge comprising:
the magnetic tape according to claim 9.

11. The magnetic tape cartridge according to claim 10,
wherein the intensity ratio is 1.5 or more and 6.0 or less.

12. The magnetic tape cartridge according to claim 10,
wherein the intensity ratio is 3.0 or more and 5.5 or less.

13. The magnetic tape cartridge according to claim 10,
wherein the ε-iron oxide powder contains a cobalt element.

14. The magnetic tape cartridge according to claim 13,
wherein the ε-iron oxide powder further contains an element selected from the group consisting of a gallium element and an aluminum element.

15. The magnetic tape cartridge according to claim 13,
wherein the ε-iron oxide powder further contains a titanium element.

16. The magnetic tape cartridge according to claim 10,
wherein the magnetic tape further comprises:
a non-magnetic layer containing a non-magnetic powder between the non-magnetic support and the magnetic layer.

17. The magnetic recording medium according to claim 10,
wherein the magnetic tape further comprises:
a back coating layer containing a non-magnetic powder on a surface side of the non-magnetic support opposite to a surface side on which the magnetic layer is provided.

18. A magnetic recording and reproducing device comprising:
the magnetic recording medium according to claim 1.
